(19) United States
(12) Patent Application Publication
(10) Pub. No.: US 2017/0023875 A1
(43) Pub. Date: Jan. 26, 2017

(54) TONER SUPPLY ROLLER AND IMAGE FORMATION DEVICE

(71) Applicant: SUMITOMO RUBBER INDUSTRIES, LTD., Kobe-shi, Hyogo (JP)

(72) Inventors: Yusuke TANIO, Kobe-shi (JP); Naoyuki SATOYOSHI, Kobe-shi (JP)

(73) Assignee: SUMITOMO RUBBER INDUSTRIES, LTD., Kobe-shi, Hyogo (JP)

(21) Appl. No.: 15/123,837

(22) PCT Filed: Jan. 28, 2015
(86) PCT No.: PCT/JP2015/052351

§ 371 Date: Sep. 6, 2016

(30) Foreign Application Priority Data
Mar. 31, 2014 (JP) 2014-073642

(51) Int. Cl. B32B 9/04

(52) U.S. Cl. CPC G03G 15/0808; B29C 47/0004; B29C 47/0016; B29C 44/02; B29C 35/045; B29C 35/0805; C08J 9/103; C08K 3/04; B29C 2035/046; B29C 2035/0855; B29K 2009/06

(57) ABSTRACT

A toner supply roller is provided which has the most uniform and greatest possible foam cell diameters and a lower hardness particularly even in a lower-temperature and lower-humidity environment as compared with the conventional art and is less liable to suffer from imaging failure such as uneven density and white streaks. An image forming apparatus employing the toner supply roller is also provided. The toner supply roller (1) is produced by preparing a rubber composition which contains a rubber component including an epichlorohydrin rubber and an acrylonitrile butadiene rubber, an electrically conductive carbon black, a crosslinking component and a foaming component and, while extruding the rubber composition into a tubular body, continuously foaming and crosslinking the rubber composition of the tubular body by a continuous crosslinking apparatus including a microwave crosslinking device and a hot air crosslinking device. The image forming apparatus incorporates the toner supply roller (1).

### TECHNICAL FIELD

The present invention relates to a toner supply roller for supplying toner to a surface of a toner carrier in an electrophotographic image forming apparatus, and to an image forming apparatus employing the toner supply roller.

### BACKGROUND ART

In an electrophotographic image forming apparatus such as a laser printer, an electrostatic copying machine, a plain paper facsimile machine or a printer-copier-facsimile multifunction machine, an image is generally formed on a surface of a sheet such as a paper sheet or a plastic film through the following process steps.

First, a surface of a photoreceptor body having photoelectric conductivity is evenly electrically charged and, in this state, exposed to light, whereby an electrostatic latent image corresponding to the image to be formed on the sheet is formed on the surface of the photoreceptor body (charging step and exposing step).

Then, toner (minute color particles) preliminarily electrically charged at a predetermined potential is brought into contact with the surface of the photoreceptor body. Thus, the toner selectively adheres to the surface of the photoreceptor body according to the potential pattern of the electrostatic latent image, whereby the electrostatic latent image is developed into a toner image (developing step).

Subsequently, the toner image is transferred onto the surface of the sheet (transfer step), and fixed to the surface of the sheet (fixing step). Thus, the image is formed on the surface of the sheet.

In the developing step of the aforementioned process steps, a toner supply roller made of a rubber foam having a predetermined roller resistance is used for supplying the toner to a surface of a toner carrier, such as a developing roller, for developing the electrostatic latent image formed on the surface of the photoreceptor body into the toner image.

The toner supply roller is required to have the lowest possible hardness so as not to break toner particles held between the toner carrier and the toner supply roller and to contain foam cells having the most uniform and greatest possible cell diameters so as to transport a sufficient amount of the toner to the toner carrier by a single transport operation.

To satisfy the requirements, PTL 1 proposes to prepare a rubber composition by blending a rubber component, a crosslinking component for crosslinking the rubber component, and a foaming component for foaming the rubber component, and produce a toner supply roller having a predetermined expansion ratio and a predetermined cell diameter distribution by extruding the rubber composition into a tubular body, and then foaming and crosslinking the rubber component of the tubular body in a crosslinking can by pressure and heat.

An ion-conductive epichlorohydrin rubber and at least one rubber selected from the group consisting of an acrylonitrile butadiene rubber (NBR), a chloroprene rubber (CR) and an ethylene propylene diene rubber (EPDM) are used in combination as the rubber component.

### CITATION LIST

### Patent Literature

PTL 1: JP-4067893-B

### SUMMARY OF THE INVENTION

### Problem to be Solved by the Invention

According to examination conducted by the inventor of the present invention, the toner supply roller disclosed in PTL 1 is still unsatisfactory in expansion ratio and hardness.

That is, the toner supply roller has a smaller expansion ratio and smaller cell diameters, thereby failing to transport a sufficient amount of the toner to the toner carrier by a single transport operation. Further, the toner supply roller has insufficient flexibility particularly in a lower-temperature and lower-humidity environment at a temperature of 10° C. at a relative humidity of 20%, thereby failing to properly follow the surface of the toner carrier. In addition, the toner supply roller becomes harder, so that toner particles held between the toner supply roller and the toner carrier are liable to be broken.

Therefore, imaging failure is liable to occur, i.e., the formed image is liable to suffer from an uneven density and white streaks (streaked image-absent portions) extending in a sheet transportation direction particularly in the lower-temperature and lower-humidity environment.

It is an object of the present invention to provide a toner supply roller which has the most uniform and greatest possible foam cell diameters and a lower hardness particularly even in the lower-temperature and lower-humidity environment as compared with the conventional art and is less liable to suffer from the imaging failure such as the uneven density and the white streaks, and to provide an image forming apparatus employing the toner supply roller.

### Solution to Problem

According to an inventive aspect, there is provided a toner supply roller which is produced by the steps of: preparing a rubber composition which contains a rubber component including an epichlorohydrin rubber and an NBR, an electrically conductive carbon black, a crosslinking component for crosslinking the rubber component and a foaming component for foaming the rubber component; and, while extruding the rubber composition into a tubular body, continuously foaming and crosslinking the rubber composition of the tubular body by a continuous crosslinking apparatus including a microwave crosslinking device and a hot air crosslinking device.

According to another inventive aspect, there is provided an image forming apparatus incorporating the inventive toner supply roller.

### Effects of the Invention

As described above, the conventional toner supply roller disclosed in PTL 1 is produced by preparing the rubber composition which contains the rubber component including the epichlorohydrin rubber and at least one rubber selected from the group consisting of the NBR, the CR and the EPDM, extruding the rubber composition into the tubular body, and foaming and crosslinking the rubber component in a batch-type vulcanization can by pressure and heat.

Where the rubber composition containing these rubbers as the rubber component is put in the vulcanization can and foamed under pressure, however, the foaming is suppressed, making it impossible to sufficiently increase the cell diameters. In addition, where an attempt is made to increase the expansion ratio, for example, by increasing the amount of the foaming component, the foam cell diameters are liable to vary.

In PTL 1, therefore, the expansion ratio of the toner supply roller is limited to not greater than 13. With smaller cell diameters, it is impossible to transport a sufficient amount of the toner to the toner carrier by a single transport operation.

With the smaller expansion ratio and the combinational use of the aforementioned rubbers as the rubber component, as described above, the toner supply roller disclosed in PTL 1 has insufficient flexibility particularly in the lower-temperature and lower-humidity environment, failing to properly follow the surface of the toner carrier. In addition, the toner supply roller becomes harder, so that the toner particles held between the toner supply roller and the toner carrier are liable to be broken. This may result in the imaging failure such as the uneven density and the white streaks.

Problematically, the toner supply roller disclosed in PTL 1 is produced at a lower productivity at higher production costs because of the use of the batch-type vulcanization can.

In the present invention, in contrast, the NBR to be used in combination with the epichlorohydrin rubber functions to suppress the foaming unevenness as much as possible. Further, the electrically conductive carbon black, functioning to enhance a rubber component heating effect by absorption of microwaves, is blended with the rubber component including the combination of the epichlorohydrin rubber and the NBR, and the rubber composition is foamed and crosslinked in an atmospheric environment by means of the continuous crosslinking apparatus. This makes it possible to provide the toner supply roller, which has the most uniform and greatest possible foam cell diameters and a lower hardness particularly even in the lower-temperature and lower-humidity environment as compared with the conventional art and is less liable to suffer from the imaging failure such as the uneven density and the white streaks, and to provide the image forming apparatus employing the toner supply roller.

According to the present invention, the toner supply roller can be efficiently produced at a higher productivity and lower costs, as compared with the method using the batch-type vulcanization can, by continuously crosslinking and foaming the rubber composition extruded into the tubular body by means of the continuous crosslinking apparatus.

### BRIEF DESCRIPTION OF THE DRAWINGS

FIG. 1 is a perspective view of an exemplary toner supply roller according to an embodiment of the present invention.

FIG. 2 is a block diagram schematically illustrating a continuous crosslinking apparatus to be used for the production of the inventive toner supply roller.

### EMBODIMENTS OF THE INVENTION

A toner supply roller according to the present invention is produced by the steps of: preparing a rubber composition containing a rubber component including an epichlorohydrin rubber and an NBR, an electrically conductive carbon black, a crosslinking component for crosslinking the rubber component and a foaming component for foaming the rubber component; and, while extruding the rubber composition into a tubular body, continuously foaming and crosslinking the rubber composition of the tubular body by means of a continuous crosslinking apparatus including a microwave crosslinking device and a hot air crosslinking device.

<<Rubber Composition>>

### <Rubber Component>

As described above, at least the epichlorohydrin rubber and the NBR are used in combination as the rubber component.

The combinational use of the epichlorohydrin rubber and the NBR is also disclosed in PTL 1. The NBR to be used in combination with the epichlorohydrin rubber functions to suppress the foaming unevenness as much as possible. Further, the electrically conductive carbon black, which functions to enhance a rubber component heating effect by absorption of microwaves, is blended with the rubber component, and the rubber composition is foamed and crosslinked in an atmospheric environment by means of the continuous crosslinking apparatus. This makes it possible to provide the toner supply roller which has the most uniform and greatest possible foam cell diameters and a lower hardness particularly even in a lower-temperature and lower-humidity environment as compared with the conventional art and is less liable to suffer from the imaging failure such as the uneven density and the white streaks.

The blending of the NBR makes it possible to finely control the roller resistance of the toner supply roller.

An EPDM and/or a styrene butadiene rubber (SBR) may be additionally blended as the rubber component.

The blending of the EPDM makes it possible to impart the toner supply roller with proper ozone resistance. The blending of the SBR makes it possible to reduce the production costs of the toner supply roller, because the SBR is more versatile and less costly than the epichlorohydrin rubber and the EPDM.

(Epichlorohydrin Rubber)

Examples of the epichlorohydrin rubber include epichlorohydrin homopolymers, epichlorohydrin-ethylene oxide bipolymers (ECO), epichlorohydrin-propylene oxide bipolymers, epichlorohydrin-allylglycidylether bipolymers, epichlorohydrin-ethylene oxide-allyl glycidyl ether terpolymers (GECO), epichlorohydrin-propylene oxide-allyl glycidyl ether terpolymers and epichlorohydrin-ethylene oxide-propylene oxide-allyl glycidyl ether quaterpolymers, which may be used alone or in combination.

Of the aforementioned examples, the ethylene oxide-containing copolymers, particularly the ECO and/or the GECO are preferred as the epichlorohydrin rubber.

These copolymers preferably each have an ethylene oxide content of not less than 30 mol % and not greater than 80 mol %, particularly preferably not less than 50 mol %.

Ethylene oxide functions to reduce the roller resistance of the toner supply roller. If the ethylene oxide content is less than the aforementioned range, however, it will be impossible to sufficiently provide the roller resistance reducing function and hence to sufficiently reduce the roller resistance of the toner supply roller.

If the ethylene oxide content is greater than the aforementioned range, on the other hand, ethylene oxide is liable to be crystallized, whereby the segment motion of molecular chains is hindered to adversely increase the roller resistance of the toner supply roller. Further, the toner supply roller is liable to have a higher hardness after the crosslinking, and the rubber composition is liable to have a higher viscosity when being heat-melted before the crosslinking.

The ECO has an epichlorohydrin content that is a balance obtained by subtracting the ethylene oxide content from the total. That is, the epichlorohydrin content is preferably not less than 20 mol % and not greater than 70 mol %, particularly preferably not greater than 50 mol %.

The GECO preferably has an allyl glycidyl ether content of not less than 0.5 mol % and not greater than 10 mol %, particularly preferably not less than 2 mol % and not greater than 5 mol %.

Allyl glycidyl ether per se functions as side chains of the copolymer to provide a free volume, whereby the crystallization of ethylene oxide is suppressed to reduce the roller resistance of the toner supply roller. However, if the allyl glycidyl ether content is less than the aforementioned range, it will be impossible to provide the roller resistance reducing function and hence to sufficiently reduce the roller resistance of the toner supply roller.

Allyl glycidyl ether also functions as crosslinking sites during the crosslinking of the GECO. Therefore, if the allyl glycidyl ether content is greater than the aforementioned range, the crosslinking density of the GECO is increased, whereby the segment motion of molecular chains is hindered. This may adversely increase the roller resistance of the toner supply roller. Further, the toner supply roller is liable to suffer from reduction in tensile strength, fatigue resistance and flexural resistance.

The GECO has an epichlorohydrin content that is a balance obtained by subtracting the ethylene oxide content and the allyl glycidyl ether content from the total. That is, the epichlorohydrin content is preferably not less than 10 mol % and not greater than 69.5 mol %, particularly preferably not less than 19.5 mol % and not greater than 60 mol %.

Examples of the GECO include copolymers of the three comonomers described above in a narrow sense, as well as known modification products obtained by modifying an epichlorohydrin-ethylene oxide copolymer (ECO) with allyl glycidyl ether. In the present invention, any of these modification products may be used as the GECO.

The proportion of the epichlorohydrin rubber to be blended is preferably not less than 30 parts by mass and not greater than 70 parts by mass based on 100 parts by mass of the overall rubber component.

If the proportion of the epichlorohydrin rubber is less than the aforementioned range, it will be impossible to impart the toner supply roller with proper ion conductivity.

If the proportion of the epichlorohydrin rubber is greater than the aforementioned range, on the other hand, the proportion of the NBR is relatively reduced. Therefore, it will be impossible to provide a synergistic effect with the blending of the electrically conductive carbon black and the use of the continuous crosslinking apparatus for the foaming and the crosslinking in the atmospheric environment, making it impossible to provide the toner supply roller having the most uniform and greatest possible foam cell diameters and a lower hardness even in the lower-temperature and lower-humidity environment.

Where the EPDM is additionally used in combination with the epichlorohydrin rubber and the NBR, the proportion of the EPDM is relatively reduced, making it impossible to impart the toner supply roller with proper ozone resistance.

Where the SBR is additionally used in combination with the epichlorohydrin rubber and the NBR, the proportion of the SBR is relatively reduced, making it impossible to sufficiently provide the production cost reducing effect.

### (NBR)

The NBR is classified in a lower acrylonitrile content type, an intermediate acrylonitrile content type, an intermediate to higher acrylonitrile content type, a higher acrylonitrile content type or a very high acrylonitrile content type depending on the acrylonitrile content. Any of these types of NBRs is usable.

The NBRs include those of an oil-extension type having flexibility controlled by addition of an extension oil, and those of a non-oil-extension type containing no extension oil. Either type of NBRs is usable.

These NBRs may be used alone or in combination.

Where only the epichlorohydrin rubber and the NBR are used in combination as the rubber component, the proportion of the NBR to be blended is a balance obtained by subtracting the proportion of the epichlorohydrin rubber from the total. That is, the proportion of the NBR to be blended is preferably not less than 30 parts by mass and not greater than 70 parts by mass based on 100 parts by mass of the overall rubber component.

If the proportion of the NBR is less than the aforementioned range, it will be impossible to provide a synergistic effect with the blending of the electrically conductive carbon black and the use of the continuous crosslinking apparatus for the foaming and the crosslinking in the atmospheric environment, making it impossible to provide the toner supply roller having the most uniform and greatest possible foam cell diameters and a lower hardness even in the lower-temperature and lower-humidity environment.

If the proportion of the NBR is greater than the aforementioned range, on the other hand, the proportion of the epichlorohydrin rubber is relatively reduced, making it impossible to impart the toner supply roller with proper ion conductivity.

Where the EPDM and/or the SBR are additionally blended as the rubber component, the proportion of the NBR may be determined by subtracting the proportions of the EPDM and/or the SBR to be described later from the aforementioned proportion.

If the proportion of the NBR is excessively small, however, it will be impossible to provide the synergistic effect with the blending of the electrically conductive carbon black and the use of the continuous crosslinking apparatus for the foaming and the crosslinking in the atmospheric environment, making it impossible to provide the toner supply roller having the most uniform and greatest possible foam cell diameters and a lower hardness even in the lower-temperature and lower-humidity environment.

Therefore, the proportion of the NBR is preferably not less than 10 parts by mass based on 100 parts by mass of the overall rubber component.

Where an oil-extension type NBR is used, the proportion of the NBR is defined as the solid proportion of the NBR contained in the oil-extension type NBR.

### (EPDM)

Usable as the EPDM are various EPDMs each prepared by introducing double bonds into a main chain thereof by employing a small amount of a third ingredient (diene) in addition to ethylene and propylene. A variety of EPDM products containing different types of third ingredients in different amounts are commercially available. Typical examples of the third ingredients include ethylidene norbornene (ENB), 1,4-hexadiene (1,4-HD) and dicyclopentadiene (DCP). A Ziegler catalyst is typically used as a polymerization catalyst.

The EPDMs include those of an oil-extension type having flexibility controlled by addition of an extension oil, and those of a non-oil-extension type containing no extension oil. Either type of EPDMs is usable.

These EPDMs may be used alone or in combination.

The proportion of the EPDM to be blended is preferably not less than 5 parts by mass and not greater than 15 parts by mass based on 100 parts by mass of the overall rubber component.

If the proportion of the EPDM is less than the aforementioned range, it will be impossible to impart the toner supply roller with proper ozone resistance.

If the proportion of the EPDM is greater than the aforementioned range, on the other hand, the proportion of the epichlorohydrin rubber is relatively reduced, making it impossible to impart the toner supply roller with proper ion conductivity.

Further, the proportion of the NBR is relatively reduced. Therefore, it will be impossible to provide the synergistic effect with the blending of the electrically conductive carbon black and the use of the continuous crosslinking apparatus for the foaming and the crosslinking in the atmospheric environment, making it impossible to provide the toner supply roller having the most uniform and greatest possible foam cell diameters and a lower hardness even in the lower-temperature and lower-humidity environment.

Where an oil-extension type EPDM is used, the proportion of the EPDM is defined as the solid proportion of the EPDM contained in the oil-extension type EPDM.

(SBR)

Usable as the SBR are various SBRs synthesized by copolymerizing styrene and 1,3-butadiene by an emulsion polymerization method, a solution polymerization method and other various polymerization methods. The SBRs include those of an oil-extension type having flexibility controlled by addition of an extension oil, and those of a non-oil-extension type containing no extension oil. Either type of SBRs is usable.

According to the styrene content, the SBRs are classified into a higher styrene content type, an intermediate styrene content type and a lower styrene content type, and any of these types of SBRs is usable. Physical properties of the toner supply roller can be controlled by changing the styrene content and the crosslinking degree.

These SBRs may be used alone or in combination.

The proportion of the SBR to be blended is preferably not less than 10 parts by mass and not greater than 35 parts by mass based on 100 parts by mass of the overall rubber component.

If the proportion of the SBR is less than the aforementioned range, it will be impossible to sufficiently provide the aforementioned production cost reducing effect.

If the proportion of the SBR is greater than the aforementioned range, on the other hand, the proportion of the epichlorohydrin rubber is relatively reduced, making it impossible to impart the toner supply roller with proper ion conductivity.

Further, the proportion of the NBR is relatively reduced. Therefore, it will be impossible to provide the synergistic effect with the blending of the electrically conductive carbon black and the use of the continuous crosslinking apparatus for the foaming and the crosslinking in the atmospheric environment, making it impossible to provide the toner supply roller having the most uniform and greatest possible foam cell diameters and a lower hardness even in the lower-temperature and lower-humidity environment.

Where an oil-extension type SBR is used, the proportion of the SBR is defined as the solid proportion of the SBR contained in the oil-extension type SBR.

<Electrically Conductive Carbon Black>

Usable as the electrically conductive carbon black are various electrically conductive carbon blacks which function to enhance the rubber component heating effect by absorption of microwaves.

The blending of the electrically conductive carbon black makes it possible to impart the toner supply roller with electron conductivity as well as to provide the aforementioned function.

A preferred example of the electrically conductive carbon black is HAF (High Abrasion Furnace) carbon black, which is particularly excellent in microwave absorbing efficiency and can be homogeneously dispersed in the rubber composition.

The proportion of the electrically conductive carbon black to be blended is preferably not less than 5 parts by mass and not greater than 25 parts by mass, particularly preferably not greater than 20 parts by mass, based on 100 parts by mass of the overall rubber component.

If the proportion of the electrically conductive carbon black is less than the aforementioned range, it will be impossible to provide a synergistic effect with the combinational use of the NBR and the epichlorohydrin rubber as the rubber component and the use of the continuous crosslinking apparatus for the foaming and the crosslinking in the atmospheric environment, making it impossible to provide the toner supply roller having the most uniform and greatest possible foam cell diameters and a lower hardness even in the lower-temperature and lower-humidity environment. Further, it will be impossible to impart the toner supply roller with sufficient electron conductivity.

If the proportion of the electrically conductive carbon black is greater than the aforementioned range, on the other hand, the rubber composition is liable to be poorer in fluidity and foamability when being heat-melted, adversely making it impossible to produce the toner supply roller having the most uniform and greatest possible foam cell diameters and a lower hardness even in the lower-temperature and lower-humidity environment.

### <Foaming Component>

As the foaming component, a foaming agent which is thermally decomposed to generate gas, and a foaming assisting agent which reduces the decomposition temperature of the foaming agent for promotion of the decomposition, are generally used in combination. Particularly, a combination of an azodicarbonamide foaming agent (H₂NOCN═NCONH₂, hereinafter sometimes abbreviated as “ADCA”) and a foaming assisting agent such as urea is widely used.

However, the foaming agent such as ADCA is preferably used alone as the foaming component without the use (blending) of the foaming assisting agent which is liable to reduce the decomposition temperature to reduce the foam cell diameters.

This makes it possible to uniformly increase the foam cell diameters of the toner supply roller.

The proportion of the foaming agent to be blended is preferably not less than 1 part by mass and not greater than 5 parts by mass based on 100 parts by mass of the overall rubber component.

Where the proportion of the foaming agent is within this range, abnormal local foaming can be suppressed and, therefore, the foam cell diameters are made more uniform.

Examples of the foaming agent include azodicarbonamide (H₂NOCN═NCONH₂, ADCA), 4,4′-oxybis(benzenesulfonylhydrazide) (OBSH) and N,N-dinitrosopentamethylene tetramine (DPT), which may be used alone or in combination.

<Crosslinking Component>

The crosslinking component for crosslinking the rubber component includes a crosslinking agent, an accelerating agent and the like.

Examples of the crosslinking agent include a sulfur crosslinking agent, a thiourea crosslinking agent, a triazine derivative crosslinking agent, a peroxide crosslinking agent and various monomers, which may be used alone or in combination. Among these crosslinking agents, the sulfur crosslinking agent is preferred.

Examples of the sulfur crosslinking agent include sulfur powder and organic sulfur-containing compounds. Examples of the organic sulfur-containing compounds include tetramethylthiuram disulfide and N,N-dithiobismorpholine. Sulfur such as the sulfur powder is particularly preferred.

The proportion of the sulfur to be blended is preferably not less than 0.2 parts by mass and not greater than 5 parts by mass, particularly preferably not less than 1 part by mass and not greater than 3 parts by mass, based on 100 parts by mass of the overall rubber component.

If the proportion of the sulfur is less than the aforementioned range, the rubber composition is liable to have a lower crosslinking speed as a whole, requiring a longer period of time for the crosslinking and reducing the productivity of the toner supply roller. If the proportion of the sulfur is greater than the aforementioned range, the toner supply roller is liable to have a higher compression set after the crosslinking, or an excess amount of the sulfur is liable to bloom on an outer peripheral surface of the toner supply roller.

Examples of the accelerating agent include inorganic accelerating agents such as lime, magnesia (MgO) and litharge (PbO), and organic accelerating agents, which may be used alone or in combination.

Examples of the organic accelerating agents include: guanidine accelerating agents such as di-o-tolylguanidine, 1,3-diphenylguanidine, 1-o-tolylbiguanide and a di-o-tolylguanidine salt of dicatechol borate; thiazole accelerating agents such as 2-mercaptobenzothiazole and di-2-benzothiazyl disulfide; sulfenamide accelerating agents such as N-cyclohexyl-2-benzothiazylsulfenamide; thiuram accelerating agents such as tetramethylthiuram monosulfide, tetramethylthiuram disulfide, tetraethylthiuram disulfide and dipentamethylenethiuram tetrasulfide; and thiourea accelerating agents, which may be used alone or in combination.

According to the type of the crosslinking agent to be used, at least one optimum accelerating agent is selected from the various accelerating agents for use in combination with the crosslinking agent. For use in combination with the sulfur crosslinking agent, the accelerating agent is preferably selected from the thiuram accelerating agents and the thiazole accelerating agents.

Different types of accelerating agents have different crosslinking accelerating mechanisms and, therefore, are preferably used in combination. The proportions of the accelerating agents to be used in combination may be properly determined, and are preferably not less than 0.1 part by mass and not greater than 5 parts by mass, particularly preferably not less than 0.5 parts by mass and not greater than 2.5 parts by mass, based on 100 parts by mass of the overall rubber component.

The crosslinking component may further include an acceleration assisting agent.

Examples of the acceleration assisting agent include: metal compounds such as zinc oxide; fatty acids such as stearic acid, oleic acid and cotton seed fatty acids; and other conventionally known acceleration assisting agents, which may be used alone or in combination.

The proportion of the acceleration assisting agent to be blended may be properly determined according to the types and combination of the rubbers of the rubber component, and the types and combination of the crosslinking agent and the accelerating agent.

<Other Ingredients>

As required, various additives may be blended in the rubber composition. Examples of the additives include an acid accepting agent, a plasticizing agent, a processing aid, a degradation preventing agent, a filler, an anti-scorching agent, a UV absorbing agent, a lubricant, a pigment, an anti-static agent, a flame retarder, a neutralizing agent, a nucleating agent and a co-crosslinking agent.

In the presence of the acid accepting agent, chlorine-containing gases generated from the epichlorohydrin rubber during the crosslinking of the rubber component are prevented from remaining in the toner supply roller. Thus, the acid accepting agent functions to prevent the inhibition of the crosslinking and the contamination of the photoreceptor body, which may otherwise be caused by the chlorine-containing gases.

Any of various substances serving as acid acceptors may be used as the acid accepting agent. Preferred examples of the acid accepting agent include hydrotalcites and Magsarat which are excellent in dispersibility. Particularly, the hydrotalcites are preferred.

Where the hydrotalcites are used in combination with magnesium oxide or potassium oxide, a higher acid accepting effect can be provided, thereby more reliably preventing the contamination of the photoreceptor body.

The proportion of the acid accepting agent to be blended is preferably not less than 0.2 parts by mass and not greater than 5 parts by mass, particularly preferably not less than 0.5 parts by mass and not greater than 2 parts by mass, based on 100 parts by mass of the overall rubber component.

If the proportion of the acid accepting agent is less than the aforementioned range, it will be impossible to sufficiently provide the effect of the blending of the acid accepting agent. If the proportion of the acid accepting agent is greater than the aforementioned range, the toner supply roller is liable to have an increased hardness after the crosslinking.

Examples of the plasticizing agent include plasticizers such as dibutyl phthalate (DBP), dioctyl phthalate (DOP) and tricresyl phosphate, and waxes such as polar waxes. Examples of the processing aid include fatty acids such as stearic acid.

The proportion of the plasticizing agent and/or the processing aid to be blended is preferably not greater than 5 parts by mass based on 100 parts by mass of the overall rubber component. This prevents the contamination of the photoreceptor body, for example, when the toner supply roller is mounted in an image forming apparatus or when the image forming apparatus is operated. For this purpose, it is particularly preferred to use any of the polar waxes as the plasticizing agent.

Examples of the degradation preventing agent include various anti-aging agents and anti-oxidants.

The anti-oxidants serve to reduce the environmental dependence of the roller resistance of the toner supply roller and to suppress the increase in roller resistance during continuous energization of the toner supply roller. Examples of the anti-oxidants include nickel diethyldithiocarbamate (NOCRAC (registered trade name) NEC-P available from Ouchi Shinko Chemical Industrial Co., Ltd.) and nickel dibutyldithiocarbamate (NOCRAC NBC available from Ouchi Shinko Chemical Industrial Co., Ltd.)

Examples of the filler include zinc oxide, silica, carbon, carbon black excluding the aforementioned electrically conductive carbon black, clay, talc, calcium carbonate, magnesium carbonate and aluminum hydroxide, which may be used alone or in combination.

The mechanical strength and the like of the toner supply roller can be improved by blending the filler.

Examples of the anti-scorching agent include N-cyclohexylthiophthalimide, phthalic anhydride, N-nitrosodiphenylamine and 2,4-diphenyl-4-metyl-1-pentene, which may be used alone or in combination. Particularly, N-cyclohexylthiophthalimide is preferred.

The proportion of the anti-scorching agent to be blended is preferably not less than 0.1 part by mass and not greater than 5 parts by mass, particularly preferably not greater than 1 part by mass, based on 100 parts by mass of the overall rubber component.

The co-crosslinking agent serves to crosslink itself as well as the rubber component to increase the overall molecular weight.

Examples of the co-crosslinking agent include ethylenically unsaturated monomers typified by methacrylic esters, metal salts of methacrylic acid and acrylic acid, polyfunctional polymers utilizing functional groups of 1,2-polybutadienes, and dioximes, which may be used alone or in combination.

Examples of the ethylenically unsaturated monomers include:
(a) monocarboxylic acids such as acrylic acid, methacrylic acid and crotonic acid;
(b) dicarboxylic acids such as maleic acid, fumaric acid and itaconic acid;
(c) esters and anhydrides of the unsaturated carboxylic acids (a) and (b);
(d) metal salts of the monomers (a) to (c);
(e) aliphatic conjugated dienes such as 1,3-butadiene, isoprene and 2-chloro-1,3-butadiene;
(f) aromatic vinyl compounds such as styrene, α-methylstyrene, vinyltoluene, ethylvinylbenzene and divinylbenzene;
(g) hetero ring-containing vinyl compounds such as triallyl isocyanurate, triallyl cyanurate and vinylpyridine; and
(h) cyanovinyl compounds such as (meth)acrylonitrile and α-chloroacrylonitrile, acrolein, formyl sterol, vinyl methyl ketone, vinyl ethyl ketone and vinyl butyl ketone. These ethylenically unsaturated monomers may be used alone or in combination.

Monocarboxylic acid esters are preferred as the esters (c) of the unsaturated carboxylic acids.

Specific examples of the monocarboxylic acid esters include:

alkyl (meth)acrylates such as methyl (meth)acrylate, ethyl (meth)acrylate, n-propyl (meth)acrylate, i-propyl (meth)acrylate, n-butyl (meth)acrylate, i-butyl (meth)acrylate, n-pentyl (meth)acrylate, i-pentyl (meth)acrylate, n-hexyl (meth)acrylate, cyclohexyl (meth)acrylate, 2-ethylhexyl (meth)acrylate, octyl (meth)acrylate, i-nonyl (meth)acrylate, tert-butylcyclohexyl (meth)acrylate, decyl (meth)acrylate, dodecyl (meth)acrylate, hydroxymethyl (meth)acrylate and hydroxyethyl (meth)acrylate;

aminoalkyl (meth)acrylates such as aminoethyl (meth)acrylate, dimethylaminoethyl (meth)acrylate and butylaminoethyl (meth)acrylate;

aromatic ring-containing (meth)acrylates such as benzyl (meth)acrylate, benzoyl (meth)acrylate and aryl (meth)acrylates;

epoxy group-containing (meth)acrylates such as glycidyl (meth)acrylate, methaglycidyl (meth)acrylate and epoxycyclohexyl (meth)acrylate;

functional group-containing (meth)acrylates such as N-methylol (meth)acrylamide, γ-(meth)acryloxypropyltrimethoxysilane and tetrahydrofurfuryl methacrylate; and

polyfunctional (meth)acrylates such as ethylene glycol di(meth)acrylate, trimethylolpropane tri(meth)acrylate, ethylene dimethacrylate (EDMA), polyethylene glycol dimethacrylate and isobutylene ethylene dimethacrylate. These monocarboxylic acid esters may be used alone or in combination.

The rubber composition containing the ingredients described above can be prepared in a conventional manner. First, the rubbers for the rubber component are blended in the predetermined proportions, and the resulting rubber component is simply kneaded. After additives other than the foaming component and the crosslinking component are added to and kneaded with the rubber component, the foaming component and the crosslinking component are finally added to and further kneaded with the resulting mixture. Thus, the rubber composition is provided. A kneader, a Banbury mixer, an extruder or the like, for example, is usable for the kneading.

### <<Toner Supply Roller>>

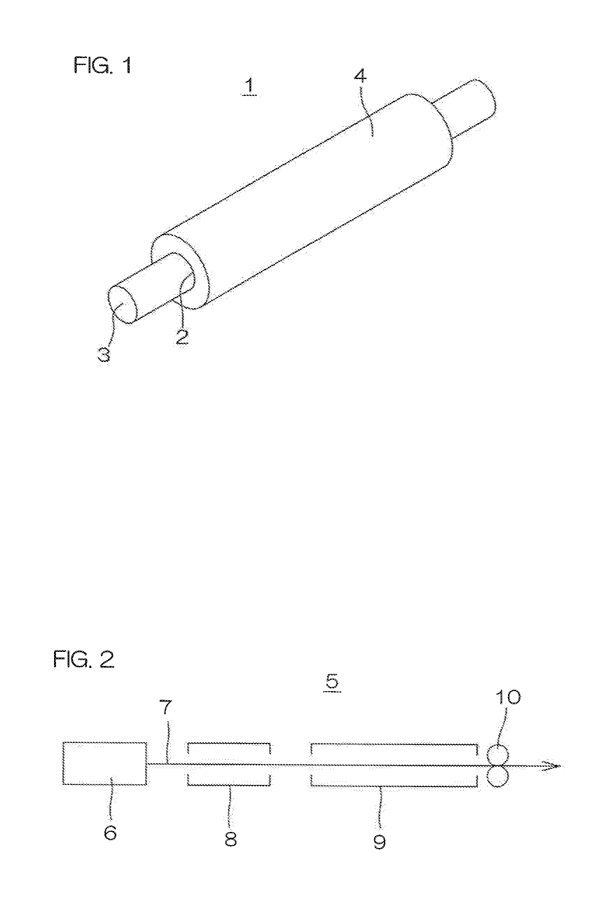

FIG. 1 is a perspective view illustrating an exemplary toner supply roller according to one embodiment of the present invention.

Referring to FIG. 1, the toner supply roller 1 according to this embodiment is a tubular body of a single layer structure formed from the rubber composition described above, and a shaft 3 is inserted through and fixed to a center through-hole 2 of the toner supply roller 1.

The shaft 3 is a unitary member made of a metal such as aluminum, an aluminum alloy or a stainless steel.

The shaft 3 is electrically connected to and mechanically fixed to the toner supply roller 1, for example, via an electrically conductive adhesive agent. Alternatively, a shaft having an outer diameter greater than the inner diameter of the through-hole 2 is used as the shaft 3, and press-inserted into the through-hole 2 to be electrically connected to and mechanically fixed to the toner supply roller 1. Thus, the shaft 3 and the toner supply roller 1 are unitarily rotatable.

As described above, the toner supply roller 1 is preferably produced by extruding the rubber composition into an elongated tubular body by means of an extruder, and continuously feeding out the extruded tubular body in the elongated state without cutting the tubular body to continuously transport the tubular body through the continuous crosslinking apparatus including the microwave crosslinking device and the hot air crosslinking device to continuously foam and crosslink the tubular body.

FIG. 2 is a block diagram for briefly explaining an example of the continuous crosslinking apparatus.

Referring to FIGS. 1 and 2, the continuous crosslinking apparatus 5 according to this embodiment includes a microwave crosslinking device 8, a hot air crosslinking device 9 and a take-up device 10 provided in this order on a continuous transportation path along which an elongated tubular body 7 formed by continuously extruding the rubber composition by an extruder 6 for the toner supply roller 1 is continuously transported in the elongated state without cutting by a conveyor (not shown) or the like. The take-up device 10 is adapted to take up the tubular body 7 at a predetermined speed.

First, the ingredients described above are mixed and kneaded together. The resulting rubber composition is formed into a ribbon shape, and continuously fed into the extruder 6 to be continuously extruded into the elongated tubular body 7 by operating the extruder 6.

In turn, the extruded tubular body 7 is continuously transported at the predetermined speed by the conveyor and the take-up device 10 to be passed through the microwave crosslinking device 8 of the continuous crosslinking apparatus 5, whereby the rubber composition forming the tubular body 7 is crosslinked to a certain crosslinking degree by irradiation with microwaves. Further, the inside of the microwave crosslinking device 8 is heated to a predetermined temperature, whereby the rubber composition is further crosslinked, and foamed by decomposition of the foaming agent.

Subsequently, the tubular body 7 is further transported to be passed through the hot air crosslinking device 9, whereby hot air is applied to the tubular body 7. Thus, the rubber composition is further foamed by the decomposition of the foaming agent, and crosslinked to a predetermined crosslinking degree.

Then, the tubular body 7 is cooled. Thus, a foaming and crosslinking step is completed, in which the tubular body 7 is foamed and crosslinked.

The continuous crosslinking apparatus 5 is detailed, for example, in PTL 1 described above and the like.

The tubular body 7 formed from the rubber composition as having a crosslinking degree and a foaming degree each controlled at a desired level can be continuously provided by properly setting the transportation speed of the tubular body 7, the microwave irradiation dose of the microwave crosslinking device 8, the temperature setting and the length of the hot air crosslinking device 9, and the like (the microwave crosslinking device 8 and the hot air crosslinking device 9 may be each divided into a plurality of sections, and microwave irradiation doses and temperature settings at these sections may be changed stepwise).

The tubular body 7 being transported may be twisted so that the microwave irradiation dose and the heating degree can be made more uniform throughout the entire tubular body 7 to make the crosslinking degree and the foaming degree of the tubular body 7 more uniform.

The continuous crosslinking with the use of the continuous crosslinking apparatus 5 improves the productivity of the tubular body 7, and further reduces the production costs of the toner supply roller 1.

Thereafter, the tubular body 7 thus foamed and crosslinked is cut to a predetermined length, and heated in an oven or the like for secondary crosslinking. Then, the resulting tubular body is cooled, and polished to a predetermined outer diameter. Thus, the inventive toner supply roller 1 is produced.

The shaft 3 may be inserted into and fixed to the through-hole 2 at any time between the cutting of the tubular body 7 and the polishing of the tubular body 7.

However, the tubular body is preferably secondarily crosslinked and polished with the shaft 3 inserted in the through-hole 2 thereof after the cutting. This prevents the warpage and the deformation of the toner supply roller 1 which may otherwise occur due to the expansion and the contraction of the tubular body 7 during the secondary crosslinking. Further, the tubular body may be polished while being rotated about the shaft 3. This improves the polishing process efficiency, and suppresses the deflection of the outer peripheral surface 4.

Where the outer diameter of the shaft 3 is greater than the inner diameter of the through-hole 2, as described above, the shaft 3 may be press-inserted into the through-hole 2. Alternatively, the shaft 3 may be inserted into the through-hole 2 of the tubular body 7 before the secondary crosslinking, and fixed to the tubular body 7 with an electrically conductive thermosetting adhesive agent.

In the latter case, the thermosetting adhesive agent is cured by the heating in the oven during the secondary crosslinking of the tubular body 7, whereby the shaft 3 is electrically connected to and mechanically fixed to the toner supply roller 1.

In the former case, the electrical connection and the mechanical fixing are achieved upon the insertion of the shaft 3.

### <<Image Forming Apparatus>>

An image forming apparatus according to the present invention incorporates the inventive toner supply roller. Examples of the inventive image forming apparatus include various electrophotographic image forming apparatuses such as laser printers, electrostatic copying machines, plain paper facsimile machines and printer-copier-facsimile multifunction machines.

### EXAMPLES

### Example 1

### (Preparation of Rubber Composition)

A rubber component was prepared by blending 50 parts by mass of a GECO (HYDRIN (registered trade name) T3108 available from Zeon Corporation) and 50 parts by mass of an NBR (non-oil-extension and lower-acrylonitrile-content type NBR JSR N250SL available from JSR Co., Ltd. and having an acrylonitrile content of 20%).

A rubber composition was prepared by blending 10 parts by mass of electrically conductive carbon black (HAF SEAST 3 (trade name) available from Tokai Carbon Co., Ltd.) and ingredients shown below in Table 1 with 100 parts by mass of the overall rubber component, and kneading the resulting mixture by means of a Banbury mixer.

TABLE 1

| Ingredients | Parts by mass |
|---|---|
| Foaming agent | 4.0 |
| Acid accepting agent | 1.0 |
| Crosslinking agent | 1.6 |
| Accelerating agent DM | 1.6 |
| Accelerating agent TS | 2.0 |

The ingredients shown in Table 1 are as follows. The amounts (parts by mass) of the ingredients shown in Table 1 are based on 100 parts by mass of the overall rubber component.
Foaming agent: ADCA (VINYFOR AC#3 (trade name) available from Eiwa Chemical Industry Co., Ltd.)
Acid accepting agent: Hydrotalcites (DHT-4A-2 available from Kyowa Chemical Industry Co., Ltd.)
Crosslinking agent: Sulfur powder (available from Tsurumi Chemical Industry Co., Ltd.)
Accelerating agent DM: Di-2-benzothiazyl disulfide (SUNSINE MBTS (trade name) available from Shandong Shanxian Chemical Co., Ltd.)
Accelerating agent TS: Tetramethylthiuram disulfide (SANCELER (registered trade name) TS available from Sanshin Chemical Industry Co., Ltd.)

### (Production of Toner Supply Roller by Continuous Process)

The rubber composition thus prepared was fed into the extruder 6, and extruded into an elongated tubular body having an outer diameter of 10 mm and an inner diameter of 3.0 mm by the extruder. The extruded tubular body 7 was continuously fed out in an elongated state without cutting to be continuously passed through the continuous crosslinking apparatus 5 including the microwave crosslinking device 8 and the hot air crosslinking device 9, whereby the rubber composition of the tubular body was continuously foamed and crosslinked.

The microwave crosslinking device 8 had an output of 6 to 12 kW and an internal control temperature of 150° C. to 250° C. The hot air crosslinking device 9 had an internal control temperature of 150° C. to 250° C. and an effective heating chamber length of 8 m.

The foamed tubular body 7 had an outer diameter of about 16 mm.

In turn, the tubular body 7 was cut to a predetermined length. The resulting tubular body was fitted around a shaft 3 having an outer diameter of 5 mm and an outer peripheral surface 4 to which an electrically conductive thermosetting adhesive agent was applied, and heated in an oven at 160° C. for 60 minutes, whereby the tubular body 7 was secondarily crosslinked and the thermosetting adhesive agent was cured. Thus, the tubular body 7 was electrically connected to and mechanically fixed to the shaft 3.

Opposite end portions of the tubular body 7 were cut, and the outer peripheral surface 4 of the tubular body 7 was polished by a traverse polishing process utilizing a cylindrical polisher to be finished having an outer diameter of 13.0 mm (with a tolerance of ±0.1 mm). Thus, a toner supply roller 1 was produced.

### Example 2

A rubber composition was prepared in substantially the same manner as in Example 1, except that 10 parts by mass of an EPDM (ESPRENE (registered trade name) 505A available from Sumitomo Chemical Co., Ltd) was further blended as the rubber component and the proportion of the NBR was 40 parts by mass. Then, a toner supply roller was produced in substantially the same manner as in Example 1 by using the rubber composition thus prepared.

### Example 3

A rubber composition was prepared in substantially the same manner as in Example 2, except that 15 parts by mass of an SBR (non-oil-extension type JSR 1502 available from JSR Co., Ltd.) was further blended as the rubber component and the proportion of the NBR was 25 parts by mass. Then, a toner supply roller was produced in substantially the same manner as in Example 2 by using the rubber composition thus prepared.

### Conventional Example 1

### (Preparation of Rubber Composition)

A rubber component was prepared by blending 50 parts by mass of the GECO and 50 parts by mass of the NBR.

Then, a rubber composition was prepared by blending ingredients shown below in Table 2 with 100 parts by mass of the overall rubber component, and kneading the resulting mixture by means of a Banbury mixer.

TABLE 2

| Ingredients | Parts by mass |
|---|---|
| Foaming agent | 10.0 |
| Foaming assisting agent | 1.0 |
| Acid accepting agent | 1.0 |
| Crosslinking agent | 1.6 |
| Accelerating agent DM | 1.6 |
| Accelerating agent TS | 2.0 |

A urea foaming assisting agent (CELLPASTE 101 (trade name) available from Eiwa Chemical Industry Co., Ltd.) was used as the foaming assisting agent out of the ingredients shown in Table 2, and the other ingredients were the same as those shown in Table 1. The amounts (parts by mass) of the ingredients shown in Table 2 are based on 100 parts by mass of the overall rubber component.

### (Production of Toner Supply Roller by Batch Process)

The rubber composition thus prepared was fed into the extruder, and extruded into a tubular body having an outer diameter of 10 mm and an inner diameter of 3.0 mm. Then, the tubular body was cut to a predetermined length, and fitted around a temporary crosslinking shaft having an outer diameter of 2.2 mm.

Subsequently, the resulting tubular body was pressurized and heated in a vulcanization can at 120° C. for 10 minutes and then at 160° C. for 20 minutes by pressurized steam. Thus, the tubular body was foamed by a gas generated by decomposition of the foaming agent and, at the same time, the rubber component was crosslinked. The foamed tubular body had an outer diameter of 35 mm.

Then, the resulting tubular body was removed from the temporary shaft, then fitted around a shaft having an outer diameter of 5 mm and an outer peripheral surface to which an electrically conductive thermosetting adhesive agent was applied, and heated at 160° C. for 60 minutes in an oven. Thus, the rubber component was secondarily crosslinked, and the thermosetting adhesive agent was cured, whereby the tubular body was electrically connected to and mechanically fixed to the shaft.

Thereafter, opposite end portions of the tubular body were cut, and the outer peripheral surface of the tubular body was polished by a traverse polishing process utilizing a cylindrical polisher to be finished having an outer diameter of 13.0 mm (with a tolerance of ±0.1 mm). Thus, a toner supply roller was produced.

This toner supply roller corresponds to the toner supply roller disclosed in PTL 1.

### Comparative Example 1

A toner supply roller was produced in substantially the same manner as in Example 1 by a continuous process with the use of the continuous crosslinking apparatus, except that the rubber composition prepared in Conventional Example 1 was used.

### Comparative Example 2

A toner supply roller was produced in substantially the same manner as in Conventional Example 1 by a batch process with the use of a vulcanization can, except that the rubber composition prepared in Example 1 was used.

### <Evaluation of Image in Lower-Temperature and Lower-Humidity Environment>

The toner supply rollers produced in Examples, Comparative Examples and Conventional Example were each mounted in place of an original toner supply roller in a toner cartridge of a laser printer (HL-2240D available from Brother Industries, Ltd.), and then the toner cartridge was mounted in the laser printer. An image was formed sequentially on 1000 A4-size paper sheets (4200MP sheets available from Fuji Xerox Co., Ltd.) at a printing percentage of 1% in a lower-temperature and lower-humidity environment at a temperature of 10° C. at a relative humidity of 20%.

Then, a monochromatic half-tone image was formed on ten sheets, and evaluated against imaging failure on the following criteria:
Good (∘): Imaging failure such as uneven image density and white streaks was observed on none of the sheets.
Unacceptable (×): Apparent imaging failure such as uneven image density and white streaks was observed on at least one of the ten sheets.

Results are shown in Tables 3.

TABLE 3

| | | | | | |
|---|---|---|---|---|---|
| | | | Conventional | Comparative | Comparative |
| Example 1 | Example 2 | Example 3 | Example 1 | Example 1 | Example 2 |

Parts by mass

| | | | | | | |
|---|---|---|---|---|---|---|
| GECO | 50 | 50 | 50 | 50 | 50 | 50 |
| NBR | 50 | 40 | 25 | 50 | 50 | 50 |
| EPDM | — | 10 | 10 | — | — | — |
| SBR | — | — | 15 | — | — | — |
| HAF | 10 | 10 | 10 | — | — | 10 |
| Foaming agent | 4.0 | 4.0 | 4.0 | 10.0 | 10.0 | 4.0 |
| Foaming assisting agent | — | — | — | 1.0 | 1.0 | — |
| Acid accepting agent | 1.0 | 1.0 | 1.0 | 1.0 | 1.0 | 1.0 |
| Crosslinking agent | 1.6 | 1.6 | 1.6 | 1.6 | 1.6 | 1.6 |
| Accelerating agent DM | 1.6 | 1.6 | 1.6 | 1.6 | 1.6 | 1.6 |
| Accelerating agent TS | 2.0 | 2.0 | 2.0 | 2.0 | 2.0 | 2.0 |
| Production method | Continuous | Continuous | Continuous | Batch | Continuous | Batch |
| | process | process | process | process | process | process |
| Image evaluation | ∘ | ∘ | ∘ | x | x | x |

The results for Conventional Example 1 in Table 3 indicate that the toner supply roller produced by the batch process with the use of the rubber composition containing the epichlorohydrin rubber and the NBR as the rubber component but not containing the electrically conductive carbon black as disclosed in PTL 1 suffered from the imaging failure particularly in the lower-temperature and lower-humidity environment. The results for Comparative Example 1 indicate that the toner supply roller produced by the continuous process with the use of the same rubber composition as described above also suffered from the imaging failure in the lower-temperature and lower-humidity environment. Further, it was found that the toner supply roller produced with the use of the rubber composition containing the epichlorohydrin rubber and the NBR as the rubber component and containing the electrically conductive carbon black as in the present invention but by the batch process also suffered from the imaging failure in the lower-temperature and lower-humidity environment.

In contrast, the results for Examples 1 to 3 in Table 3 indicate that the toner supply rollers produced by the continuous process with the use of the rubber composition containing the epichlorohydrin rubber and the NBR as the rubber component and containing the electrically conductive carbon black were capable of preventing the imaging failure in the lower-temperature and lower-humidity environment.

Further, the results for Examples 1 to 3 indicate that the EPDM and/or the SBR may be blended as the rubber component.

### DESCRIPTION OF REFERENCE CHARACTERS

1 TONER SUPPLY ROLLER
2 THROUGH-HOLE
3 SHAFT
4 OUTER PERIPHERAL SURFACE
5 CONTINUOUS CROSSLINKING APPARATUS
6 EXTRUDER
7 TUBULAR BODY
8 MICROWAVE CROSSLINKING DEVICE
9 HOT AIR CROSSLINKING DEVICE
10 TAKE-UP DEVICE

1. A toner supply roller which is produced by the steps of:
preparing a rubber composition which comprises a rubber component including an epichlorohydrin rubber and an acrylonitrile butadiene rubber, an electrically conductive carbon black, a crosslinking component for crosslinking the rubber component, and a foaming component for foaming the rubber component; and
while extruding the rubber composition into a tubular body, continuously foaming and crosslinking the rubber composition of the tubular body by a continuous crosslinking apparatus including a microwave crosslinking device and a hot air crosslinking device.

2. The toner supply roller according to claim 1, wherein the rubber component further includes an ethylene propylene diene rubber.

3. The toner supply roller according to claim 2, wherein the rubber component further includes a styrene butadiene rubber.

4. An image forming apparatus incorporating the toner supply roller according to claim 1.

5. The toner supply roller according to claim 1, wherein the rubber component further includes a styrene butadiene rubber.

6. An image forming apparatus incorporating the toner supply roller according to claim 2.

7. An image forming apparatus incorporating the toner supply roller according to claim 3.

8. An image forming apparatus incorporating the toner supply roller according to claim 5.

9. The toner supply roller according to claim 1, wherein the epichlorohydrin rubber is epichlorohydrin-ethylene oxide bipolymers (ECO) having an ethylene oxide content of not less than 30 mol % and not greater than 50 mol %.

10. The toner supply roller according to claim 1, wherein the epichlorohydrin rubber is epichlorohydrin-ethylene oxide-allyl glycidyl ether terpolymers (GECO) having an ethylene oxide content of not less than 30 mol % and not greater than 50 mol %.
